(19) United States
(12) Patent Application Publication
(10) Pub. No.: US 2025/0276569 A1
(43) Pub. Date: Sep. 4, 2025

(54) PLASTIC COMPONENT, IN PARTICULAR UNDERRIDE GUARD, HAVING FIRE-RESISTANT TEXTILE FOR AN AT LEAST PARTIALLY ELECTRICALLY DRIVEN MOTOR VEHICLE

(71) Applicant: AUDI AG, Ingolstadt (DE)

(72) Inventor: Julius RAUSCH, Heilbronn (DE)

(73) Assignee: AUDI AG, Ingolstadt (DE)

(21) Appl. No.: 18/702,570

(22) PCT Filed: Dec. 20, 2022
(86) PCT No.: PCT/EP2022/086836

§ 371 Date: Apr. 18, 2024

(30) Foreign Application Priority Data
Dec. 20, 2021 (DE) 10 2021 133 799.2

(51) Int. Cl. B60K 1/04; B60L 50/60; H01M 50/229; H01M 50/24; H01M 50/249; H01M 50/30

(52) U.S. Cl. CPC B60K 1/04; B60L 50/60; H01M 50/229; H01M 50/24; H01M 50/249; B60K 2001/0438; H01M 50/30; H01M 2220/20

(57) ABSTRACT

A plastic component, in particular as an underride guard, for an at least partially electrically driven motor vehicle having a base plate made of a first plastic material and with a plurality of support portions protruding from the base plate, which are designed to support the plastic component on a vehicle component to be protected by the plastic component, in particular a battery storage device. The plastic component has at least one flat fire-resistant textile, which is arranged between protruding support portions and is connected to the base plate in a material-locking manner.

### FIELD

The invention relates to a plastic component for an at least partially electrically driven motor vehicle with a base plate made of a first plastic material and with a plurality of support portions protruding from the base plate, which are designed to support the plastic component on a vehicle component to be protected by the plastic component. The invention further relates to an underride guard and an at least partially electrically driven motor vehicle with such an underride guard.

### BACKGROUND

Such a plastic component is used in at least partially electrically driven motor vehicles, particularly in the region of a battery storage device, to cover them upwards towards structural components of the body or towards a vehicle interior or downwards towards a ground. In such battery storage devices, it can happen in rare cases that a battery cell degasses, causing hot gas to escape.

Different approaches are known from the prior art in relation to protective measures in connection with battery storage devices. Reference is made to the following documents as examples: DE 10 2019 130 097 A1, DE 10 2017 000 265 A1, DE 42 32 961 A1 and DE 10 2008039 866 A1.

### SUMMARY

The object of the invention is to provide a plastic component that can also serve as a protective element in the event of escaping hot gas, wherein it in particular can also be used as underride guard.

This object is achieved by a plastic component, an underride guard and a motor vehicle

A plastic component is thus proposed for an at least partially electrically driven motor vehicle with a base plate made of a first plastic material; and with a plurality of support portions protruding from the base plate, which are designed to support the plastic component on a vehicle component to be protected by the plastic component. It is provided that the plastic component has at least one flat fire-resistant textile, which is arranged between protruding support portions and is connected to the base plate in a material-locking manner.

As a result, the plastic component can be protected against the escape of hot gas, particularly in regions in which a fire-resistant textile is arranged.

In the case of the plastic component, the fire-resistant textile can be designed as a flat strip and have a strip length that corresponds to approximately 75% to 98% of the length of the base plate. The flat strip can have a strip length of at least 100 cm and a strip width of at least 5 cm. Furthermore, it is possible for multiple such strips of fire-resistant textile material to be arranged parallel to one another on the base plate.

Alternatively, in the case of the plastic component, the base plate can have a plurality of intersecting support portions, such that the intersecting support portions form polygonal enclosures, wherein a respective flat fire-resistant textile is arranged in multiple or all the enclosures. A fire-resistant textile arranged in an enclosure can have a textile width of at least 5 cm and a textile length of at least 15 cm.

The intersecting support portions can, for example, form a kind of regular grid of enclosures, so that flat fire-resistant textiles can also be arranged on the base plate in such a regular grid.

In the case of the plastic component, the support portions can be made of glass fiber reinforced plastic material, and in particular can be formed with the base plate in an injection molding process or an extrusion process.

The fire-resistant textile can in particular contain non-combustible mineral fibers, such as glass fibers and/or carbon fibers and/or basalt fibers and the like. Furthermore, the fire-resistant textile can have a dense or compact structure, wherein it can be designed as a woven fabric, a mat, fleece or scrim with different basis weights.

An underride guard for an at least partially electrically driven motor vehicle is also proposed, wherein the underride guard is designed as a plastic component as described above. Such an underride guard is attached in particular to the underside of a battery storage device.

A motor vehicle with at least partially electric drive and a battery storage device is also proposed, wherein the motor vehicle has such an underride guard which is arranged underneath the battery storage device and is connected directly or indirectly therewith, and wherein the support portions of the underride guard face the battery storage device and are supported thereon.

In the motor vehicle, the battery storage device can have multiple battery cells which have a respective degassing opening, wherein the degassing openings are arranged on an underside of the battery cells.

In the motor vehicle, the underride guard can be designed in such a way that a respective fire-resistant textile is arranged opposite each of the downward-oriented degassing openings or that a common fire-resistant textile is arranged opposite multiple downward-oriented degassing openings.

In other words, for example, a strip-like fire-resistant textile, as described above, can lie opposite multiple degassing openings of battery cells, which openings are arranged along the strip. Based on a width direction of the strip, the degassing openings can be arranged centrally opposite the strip.

Alternatively, in the case of multiple fire-resistant textiles arranged in a grid-like manner on the underride guard, a flat fire-resistant textile can be associated with a respective degassing opening of a battery cell and arranged opposite the same. The degassing openings and the associated fire-resistant textiles can in particular be aligned essentially centered relative to one another, in particular so that the degassing opening lies opposite an imaginary center of area of the fire-resistant textile.

### BRIEF DESCRIPTION OF THE FIGURES

Further advantages and details of the invention result from the following description of embodiments with reference to the figures. In the figures:

FIG. 1 shows simplified and schematic examples of plastic components in a plan view in sub-figures A) and B), and associated sectional views corresponding to the specified section lines C-C and D-D in sub-figures C) and D);

FIG. 2 shows a simplified and schematic sectional view, approximately corresponding to a view in FIG. 1C, of a plastic component that is arranged as underride guard beneath a battery storage device;

FIG. 3 shows a simplified and schematic view of an at least partially electrically driven motor vehicle with a battery storage device and an underride guard.

### DETAILED DESCRIPTION

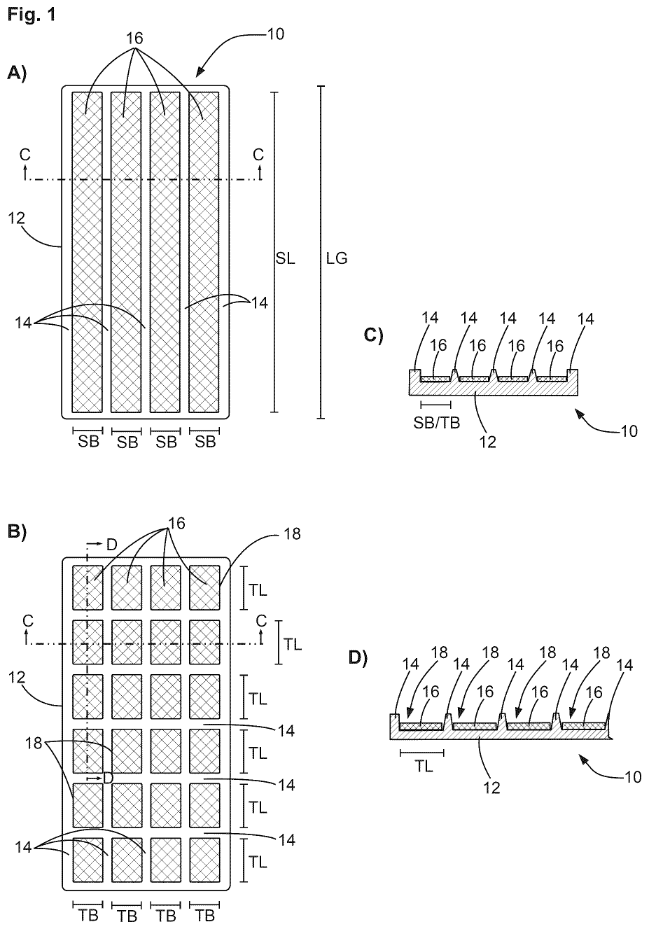

FIG. 1 shows two examples of a plastic component 10 in partial figures A) and B) in a simplified and schematic plan view. Sub-figures C) and D) contain corresponding sectional views. In the following, reference is made to all sub-figures A) to D) of FIG. 1 in order to describe the plastic components 10 in more detail.

The plastic components 10 have a respective base plate 12, which are made from a first plastic material. Furthermore, the plastic components 10 each include a plurality of support portions 14 protruding from the base plate 12. The support portions 14 are designed in particular to support the plastic component 10 on a vehicle component to be protected by the plastic component 10.

The plastic components 10 each comprise multiple flat fire-resistant textiles 16, which are each arranged between protruding support portions 14 and are connected to the base plate 12 in a material-locking manner.

In the example of FIG. 1A, the fire-resistant textiles 16 are designed as flat strips. The strip-like fire-resistant textiles have a strip length SL, which corresponds to approximately 75% to 98% of the length LG of the base plate 12. These strip-like fire-resistant textiles 16 can have a strip length SL of at least 100 cm and a strip width SB of at least 5 cm.

In the example of FIG. 1B, the base plate 12 has a plurality of intersecting support portions 16. The intersecting support portions 16 form polygonal, in particular rectangular, enclosures 18. Respective flat fire-resistant textiles 16 are arranged in the enclosures 18. A fire-resistant textile 16 arranged in an enclosure 18 can have a textile width TB of at least 5 cm and a textile length TL of at least 15 cm.

In the case of the plastic component 10, which can in particular be made from a thermoplastic material or a composite material, the support portions 14 can be made from glass fiber reinforced plastic material. The support portions 14 can be formed with the base plate 12 in particular in an injection molding process or an extrusion process. The support portions 14 can be made from the same or a different material with respect to the base plate 12.

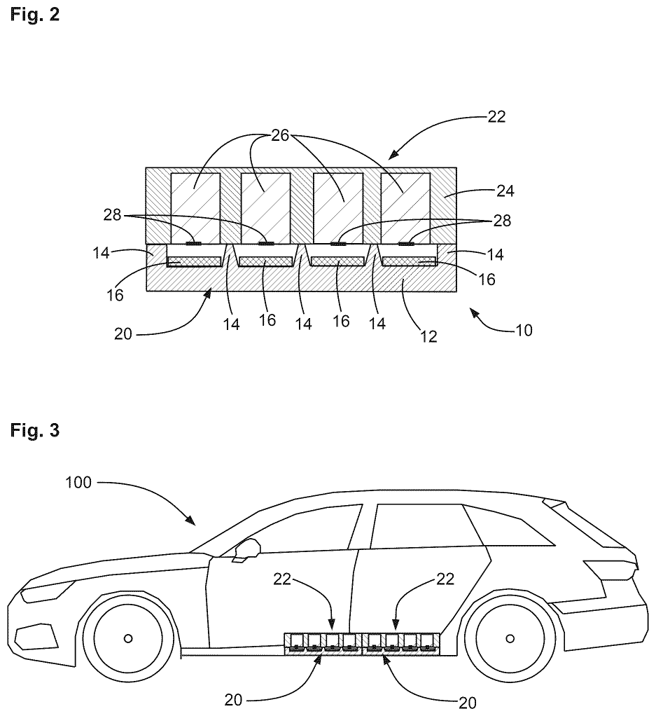

FIG. 2 shows in a simplified and schematic sectional view the use of a plastic component 10, as shown in FIG. 1, as an underride guard 20 for an at least partially electrically driven motor vehicle 100, which is shown in FIG. 3.

The underride guard 20 forms a lower cover for a battery storage device 22 and is connected thereto directly or indirectly. In other words, the underride guard 20 can be directly connected to a housing 24 of the battery storage device, for example by material-locking connection and/or in a form-fitting manner. Alternatively or additionally, the underride guard 20 can also be fastened to structural components of the motor vehicle 100, for example by means of screws or the like.

A plurality of battery cells 26 are accommodated in the housing 24 of the battery storage device 22. The battery cells 26 are designed so that they each have a degassing opening 28 arranged on a lower edge. The support portions 14 of the underride guard 20 face the battery storage device 22 and are supported thereon.

The underride guard 20 is designed in such a way that a respective fire-resistant textile 16 is arranged opposite each of the downward-oriented degassing openings 28 or that a common fire-resistant textile 16 is arranged opposite multiple downward-oriented degassing openings 28.

In other words, for example, a strip-like fire-resistant textile 16, as shown and described above in FIG. 1A, can lie opposite multiple degassing openings 28 of battery cells 26, which openings are arranged along the strip. Based on a width direction SB of the strip, the degassing openings 28 can be arranged centrally opposite the strip.

Alternatively, in the case of multiple fire-resistant textiles 16 (see FIG. 1B) arranged in a grid-like manner on the underride guard 20, a flat fire-resistant textile 16 can be associated with a respective degassing opening 28 of a battery cell 26 and arranged opposite the same. The degassing openings 28 and the associated fire-resistant textiles 16 can in particular be aligned essentially centered relative to one another, in particular so that the degassing opening 28 lies opposite an imaginary center of area of the fire-resistant textile 16.

1-10. (canceled)

11. A plastic component for an at least partially electrically driven motor vehicle, comprising:
a base plate made of a first plastic material;
multiple support portions protruding from the base plate, which are designed to support the plastic component on a vehicle component to be protected by the plastic component; and
at least one flat fire-resistant textile, which is arranged between protruding support portions and is connected to the base plate in a material-locking manner.

12. The plastic component according to claim 11, wherein the fire-resistant textile is designed as a flat strip and has a strip length which corresponds to approximately 75% to 98% of the length of the base plate.

13. The plastic component according to claim 12, wherein the flat strip has a strip length of at least 100 cm and a strip width of at least 5 cm.

14. The plastic component according to claim 11, wherein the base plate has multiple intersecting support portions, such that the intersecting support portions form polygonal enclosures, wherein a respective flat fire-resistant textile is arranged in multiple or all of the enclosures.

15. The plastic component according to claim 14, wherein a fire-resistant textile arranged in an enclosure has a textile width of at least 5 cm and a textile length of at least 15 cm.

16. The plastic component according to claim 11, wherein the support portions are made of glass fiber reinforced plastic and are formed in particular in an injection molding process or an extrusion process together with the base plate.

17. An underride guard for an at least partially electrically driven motor vehicle, wherein the underride guard is designed as a plastic component according to claim 11.

18. A motor vehicle with an at least partially electric drive and a battery storage device,
wherein the motor vehicle has an underride guard according to claim 17, which is arranged beneath the battery storage device and is connected directly or indirectly thereto,
wherein the support portions of the underride guard face the battery storage device and are supported thereon.

19. The motor vehicle according to claim 18, wherein the battery storage device has multiple battery cells which have a respective degassing opening, wherein the degassing openings are arranged on an underside of the battery cells.

20. The motor vehicle according to claim 19, wherein the underride guard is designed in such a way that a respective fire-resistant textile is arranged opposite each of the downward-oriented degassing openings or that a common fire-resistant textile is arranged opposite multiple downward-oriented degassing openings.

21. The plastic component according to claim 12, wherein the support portions are made of glass fiber reinforced plastic and are formed in particular in an injection molding process or an extrusion process together with the base plate.

22. The plastic component according to claim 13, wherein the support portions are made of glass fiber reinforced plastic and are formed in particular in an injection molding process or an extrusion process together with the base plate.

23. The plastic component according to claim 14, wherein the support portions are made of glass fiber reinforced plastic and are formed in particular in an injection molding process or an extrusion process together with the base plate.

24. The plastic component according to claim 15, wherein the support portions are made of glass fiber reinforced plastic and are formed in particular in an injection molding process or an extrusion process together with the base plate.
